(19) United States
(12) Patent Application Publication
(10) Pub. No.: US 2018/0090879 A1
(43) Pub. Date: Mar. 29, 2018

(54) ELECTRONIC COMPONENT RETAINING STRUCTURE, ELECTRIC CONNECTION BOX, AND WIRE HARNESS

(71) Applicant: Yazaki Corporation, Tokyo (JP)

(72) Inventors: Hirotaka Hasegawa, Shizuoka (JP); Shinya Oishi, Shizuoka (JP)

(21) Appl. No.: 15/705,028

(22) Filed: Sep. 14, 2017

(30) Foreign Application Priority Data
Sep. 28, 2016 (JP) 2016-189241

(51) Int. Cl. H01R 13/627; H01R 13/642; H02G 3/08; H01B 7/00

(52) U.S. Cl. CPC H01R 13/6273; H01B 7/0045; H02G 3/081; H01R 13/642

(57) ABSTRACT

An electric connection box includes a pair of second slits having a pair of first slits interposed therebetween in an aligning direction, penetrating a wall portion in a facing direction, extending from an insertion hole to a supporting portion side along an insertion direction, having respective front ends that are closed ends on the supporting portion side, and overlapping with the first slits in the aligning direction.

### CROSS-REFERENCE TO RELATED APPLICATION(S)

The present application claims priority to and incorporates by reference the entire contents of Japanese Patent Application No. 2016-189241 filed in Japan on Sep. 28, 2016.

### BACKGROUND OF THE INVENTION

### 1. Field of the Invention

The present invention relates to an electronic component retaining structure, an electric connection box, and a wire harness.

### 2. Description of the Related Art

Electric connection boxes (sometimes referred to as a junction box, a fuse box, a relay box, and the like) are conventionally known that are mounted on vehicles including a car and collectively accommodate parts for connection operation such as a wire harness and electronic components such as a fuse, a relay, and an electronic control unit. The electric connection box includes, for example, a tubular mounting unit for mounting an electronic component such as a relay (for example, see Japanese Patent No. 5221255).

The electric connection box has been requested to have the mounting unit elastically deformed when mounting an electronic component on the mounting unit so as to have the electronic component easily mounted thereon.

### SUMMARY OF THE INVENTION

From the above-described viewpoint, the present invention aims to provide an electronic component retaining structure, an electric connection box, and a wire harness capable of properly mounting an electronic component on the mounting unit.

In order to solve the above mentioned problem and achieve the object, an electronic component retaining structure according to one aspect of the present invention includes a tubular portion that is formed in a tubular shape and has an insertion hole to receive an electronic component inserted along an insertion direction; a supporting portion that is provided on a side opposite to the insertion hole of the tubular portion and supports the electronic component; a pair of arm portions that extends from respective edge portions of a pair of openings on the insertion hole side to the supporting portion side along the insertion direction in a cantilever manner and retains the electronic component, the openings being provided on respective wall portions facing each other of the tubular portion, facing each other, and penetrating the wall portions in a facing direction; a pair of first slits that is provided on respective sides of the arm portions in an aligning direction that is a direction intersecting with the insertion direction, along the wall portions having the openings of the tubular portion, the first slits constituting parts of the respective openings, extending from the supporting portion side to the insertion hole side along the insertion direction, and having closed ends on the insertion hole side; and a pair of second slits that is provided with the pair of first slits interposed therebetween in the aligning direction, the second slits penetrating the wall portions in the facing direction, extending from the insertion hole to the supporting portion side along the insertion direction, having closed ends on the supporting portion side, and overlapping with the pair of first slits in the aligning direction.

According to another aspect of the present invention, in the electronic component retaining structure, it is preferable that when the electronic component contacts with an inter-slit wall portion arranged between the pair of second slits in a process of the electronic component being inserted through the insertion hole, the tubular portion has the inter-slit wall portion elastically deformed.

According to still another aspect of the present invention, an electric connection box includes an electronic component; a tubular portion that is formed in a tubular shape and has an insertion hole to receive the electronic component inserted along an insertion direction; a supporting portion that is provided on a side opposite to the insertion hole of the tubular portion and supports the electronic component; a pair of arm portions that extends from respective edge portions of a pair of openings on the insertion hole side to the supporting portion side along the insertion direction in a cantilever manner and retains the electronic component, the openings being provided on respective wall portions facing each other of the tubular portion, facing each other, and penetrating the wall portions in a facing direction; a pair of first slits that is provided on respective sides of the arm portions in an aligning direction that is a direction intersecting with the insertion direction, along the wall portions having the openings of the tubular portion, the first slits constituting parts of the respective openings, extending from the supporting portion side to the insertion hole side along the insertion direction, and having closed ends on the insertion hole side; and a pair of second slits that is provided with the pair of first slits interposed therebetween in the aligning direction, the second slits penetrating the wall portions in the facing direction, extending from the insertion hole to the supporting portion side along the insertion direction, having closed ends on the supporting portion side, and overlapping with the pair of first slits in the aligning direction.

According to still another aspect of the present invention, a wire harness includes an electric connection box including: an electronic component; a tubular portion that is formed in a tubular shape and has an insertion hole to receive the electronic component inserted along an insertion direction; a supporting portion that is provided on a side opposite to the insertion hole of the tubular portion and supports the electronic component; a pair of arm portions that extends from respective edge portions of a pair of openings on the insertion hole side to the supporting portion side along the insertion direction in a cantilever manner and retains the electronic component, the openings being provided on respective wall portions facing each other of the tubular portion, facing each other, and penetrating the wall portions in a facing direction; a pair of first slits that is provided on respective sides of the arm portions in an aligning direction that is a direction intersecting with the insertion direction, along the wall portions having the openings of the tubular portion, the first slits constituting parts of the respective openings, extending from the supporting portion side to the insertion hole side along the insertion direction, and having closed ends on the insertion hole side; and a pair of second slits that is provided with the pair of first slits interposed therebetween in the aligning direction, the second slits penetrating the wall portions in the facing direction, extending from the insertion hole to the supporting portion side along the insertion direction, having closed ends on the supporting portion side, and overlapping with the pair of first slits in the aligning direction; and an electric wire that is electrically connected with the electronic component.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an exemplary configuration of an electric connection box according to an embodiment;

FIG. 2 is a plan view illustrating an exemplary configuration of a mounting unit according to the embodiment;

FIG. 3 is a sectional view of FIG. 2 along line X1-X1 illustrating the exemplary configuration of the mounting unit according to the embodiment;

FIG. 4 is a sectional view of FIG. 2 along line X2-X2 illustrating an exemplary function of the electric connection box according to the embodiment;

FIG. 5 is another sectional view of FIG. 2 along line X2-X2 illustrating an exemplary function of the electric connection box according to the embodiment;

FIG. 6 is still another sectional view of FIG. 2 along line X2-X2 illustrating an exemplary function of the electric connection box according to the embodiment; and

FIG. 7 is still another sectional view of FIG. 2 along line X2-X2 illustrating an exemplary function of the electric connection box according to the embodiment.

### DETAILED DESCRIPTION OF THE PREFERRED EMBODIMENTS

Embodiments of the present invention will now be described in detail with reference to the drawings. It should be noted that the described embodiments are not intended to limit the scope of the present invention. Components in the following description include what the skilled person could have easily thought of and what is substantially the same. Configurations in the following description can be combined with one another at appropriate. Various omissions, modifications, and changes can be made without departing from the spirit of the present invention.

### Embodiment

An electronic component retaining structure, an electric connection box, and a wire harness according to an embodiment will now be described. An electric connection box 1 having an electronic component retaining structure la is mounted on a vehicle (not illustrated) such as a car. The electric connection box 1 collectively accommodates a connector assembled into a wire harness 100 and constituting a part for connection operation such as an electric wire 101 and electronic components such as a fuse, a relay, and an electronic control unit. The electric connection box 1 is placed, for example, in an engine room of a vehicle and in the lower part of the vehicle body and is connected between a power supply such as a battery and various kinds of electronic devices mounted on the vehicle. The electric connection box 1 distributes power supplied from the power supply to various kinds of electronic devices in the vehicle. The electric connection box 1 is sometimes referred to as a junction box, a fuse box, a relay box, and the like. In this embodiment, these boxes are collectively referred to as the electric connection box 1.

A direction in which a relay 40 serving as an electronic component is inserted will be referred to as an insertion direction, a side from which the relay 40 is inserted will be referred to as an insertion direction upper side, and a side opposite to the insertion direction upper side will be referred to as an insertion direction lower side. For convenience of description, one of two directions perpendicular to the insertion direction will be referred to as a long side direction, and the other one will be referred to as a short side direction. The insertion direction (the Z direction) as a first direction, the long side direction (the X direction) as a second direction, and the short side direction (the Y direction) as a third direction are perpendicularly intersect with one another. The long side direction will also be referred to as a facing direction in which a pair of later-described openings 33 faces each other.

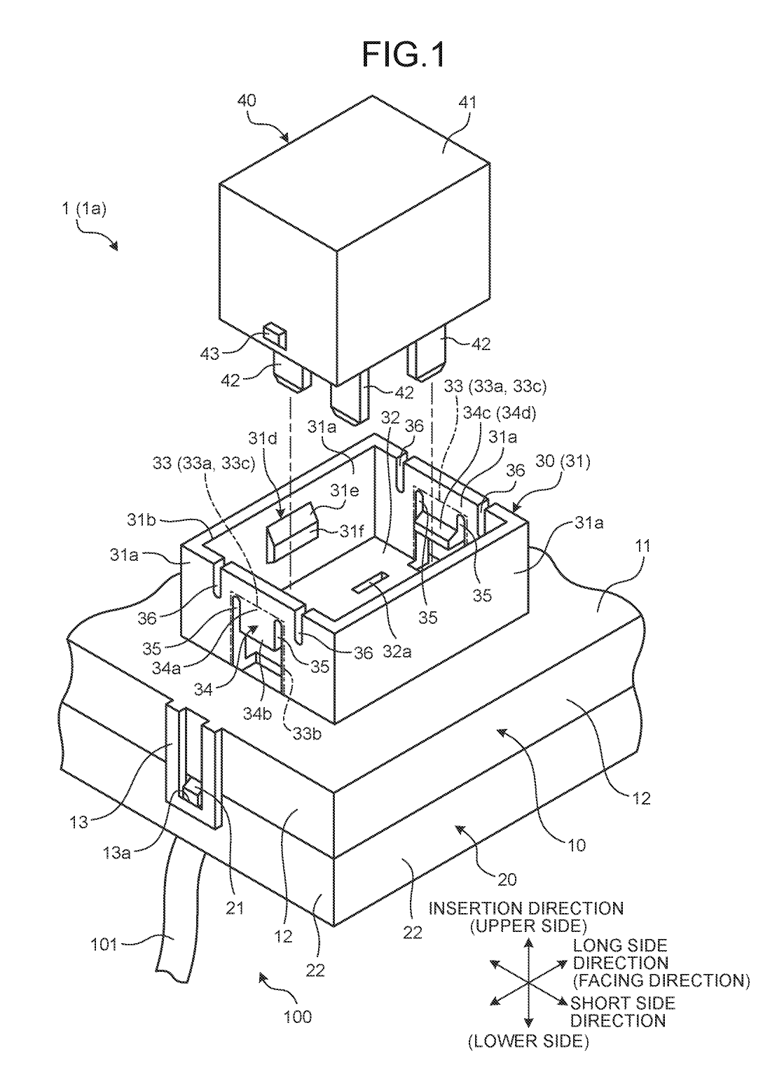

As illustrated in FIG. 1, the electric connection box 1 includes a box main body 10, a lower cover 20, a mounting unit 30, a relay 40, and a distribution board (not illustrated). The box main body 10 is made from insulating synthetic resin and is formed by known injection molding. The box main body 10 is formed in a box shape opening to the insertion direction lower side and is configured with a ceiling wall 11 and a plurality of outer walls 12 vertically arranged from the outer periphery of the ceiling wall 11 to the insertion direction lower side and continuous with one another. The box main body 10 has a space inside thereof for accommodating the distribution board.

The outer wall 12 of the box main body 10 is provided with a plurality of fixing units 13 for fixing the box main body 10 and the lower cover 20 to each other. Each fixing unit 13 has a hole portion 13a, and a fixing convex portion 21 of the later-described lower cover 20 is engaged with the hole portion 13a. With the fixing convex portion 21 of the lower cover 20 engaged with the hole portion 13a of the fixing unit 13 in the box main body 10, the lower cover 20 is fixed to a lower surface of the box main body 10 disposed in the insertion direction lower side.

The lower cover 20 is made from insulating synthetic resin and the like and is formed by known injection molding. The lower cover 20 is formed in a tubular shape with a bottom and is configured with a bottom wall (not illustrated) disposed in the insertion direction lower side and a plurality of outer walls 22 vertically arranged from the outer periphery of the bottom wall to the insertion direction upper side and continuous with one another. The outer wall 22 of the lower cover 20 has a plurality of fixing convex portions 21 engaged with respective fixing units 13 of the box main body 10. The bottom wall of the lower cover 20 disposed in the insertion direction lower side mates with a connector (not illustrated) provided to an end of the wire harness 100 connected with a various kinds of electronic devices mounted on the vehicle. The lower cover 20 is assembled to the box main body 10 in a manner covering the lower surface of the box main body 10 with each fixing convex portion 21 engaged with the hole portion 13a of the fixing unit 13 of the box main body 10.

The relay 40 includes a block-shaped main body 41 accommodating therein an internal coil and others, a plurality of conductive strip-shaped terminals 42 projecting from a bottom surface (not illustrated) disposed in the insertion direction lower side of the main body 41, and a pair of projecting portions 43 for engagement provided to side surfaces of the main body 41 in a projecting manner and facing each other. With the relay 40 mounted on the mounting unit 30, each terminal 42 is passed into a later-described through hole 32a of the mounting unit 30 and is electrically connected with a later-described bus bar of the distribution board. The projecting portions 43 are disposed in a manner facing each other along the long side direction of the main body 41. With the relay 40 mounted on the mounting unit 30, the projecting portions 43 are locked to respective claw portions 34c of later-described arm portions 34 facing each other of the mounting unit 30 and fix the relay 40 inside a tubular portion 31 of the mounting unit 30.

The distribution board includes conductive bus bars, an insulating board, and others. The bus bars are fabricated by press working such as punching on a conductive plate and are stacked on one another. The insulating board is disposed between the stacked bus bars, prevents the bus bars from electrically being connected with each other at an unintended place, in other words, from the short circuit, and positions the bus bars. With the distribution board accommodated in the box main body 10, the bus bar electrically connects the connector of the above-described wire harness 100 and the relay 40 mounted on the mounting unit 30 with each other based on a predetermined pattern.

A plurality of mounting units 30 are provided on the ceiling wall 11 in the insertion direction upper side of the box main body 10 and have electronic components such as the relay 40 mounted thereon. The mounting unit 30 includes the tubular portion 31, a supporting portion 32, a pair of openings 33, a pair of arm portions 34, a pair of first slits 35, and a pair of second slits 36. The tubular portion 31 is configured with a plurality of rectangular plate wall portions 31a continuous with one another and is formed in a tube shape. The tubular portion 31 is, for example, in a rectangular shape when viewed from the insertion direction upper side. The tubular portion 31 is vertically arranged on the ceiling wall 11 of the box main body 10 with the wall portions 31a extending along the insertion direction. The tubular portion 31 may be integrally formed with the ceiling wall 11 of the box main body 10 or may be separately formed and assembled to the ceiling wall 11 of the box main body 10. In this embodiment, the tubular portion 31 is integrally formed with the ceiling wall 11 of the box main body 10.

The tubular portion 31 is provided with a pair of guiding members 31d facing each other inside the wall portions 31a. Each guiding member 31d is disposed on the corresponding wall portion 31a having no openings 33. In this case, the guiding members 31d are disposed on the wall portions 31a facing each other in the short side direction. The guiding member 31d has an inclined surface 31e arranged in the insertion direction upper side and a vertical surface 31f arranged in a facing direction (the short side direction) in which the guiding members 31d face each other. The inclined surface 31e is a plane surface gradually inclined inward of the tubular portion 31 from the insertion direction upper side toward the insertion direction lower side. The vertical surface 31f is a plane surface parallel with the inner surface of the wall portion 31a of the tubular portion 31. A pair of inclined surfaces 31e contacts with the outer periphery of the relay 40 inserted inside the tubular portion 31 and guides the relay 40 to the center of the tubular portion 31 in the short side direction. A pair of vertical surfaces 31f supports the relay 40 such that the relay 40 is positioned in the center of the tubular portion 31 in the short side direction.

The tubular portion 31 has its inner size substantially the same as the size of the outer shape of the relay 40 when viewed from the insertion direction upper side. In other words, the tubular portion 31 has an inner length in the long side direction that is substantially the same as the length of the relay 40 including the pair of projecting portions 43 in the long side direction. Furthermore, the tubular portion 31 has an inner length in the short side direction between the pair of vertical surfaces 31f of the guiding members 31d that is substantially the same as the length of the relay 40 in the short side direction.

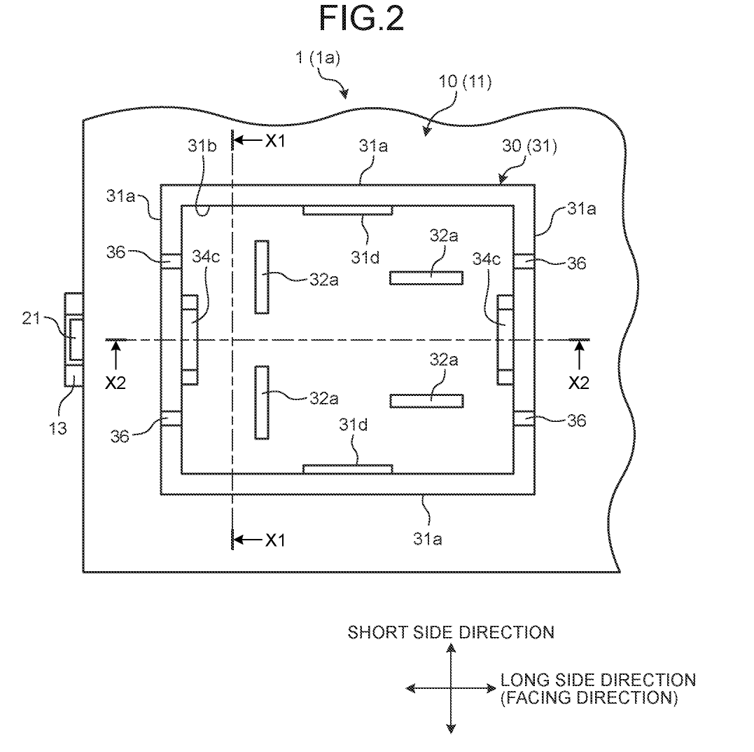

An insertion hole 31b for having the relay 40 inserted thereinto is arranged in the insertion direction upper side of the tubular portion 31, and the supporting portion 32 is arranged in the opposite side to the insertion hole 31b. The insertion hole 31b is a portion rectangularly opening in the insertion direction upper side of the tubular portion 31. The supporting portion 32 is a rectangular inner portion surrounded by the wall portions 31a on the ceiling wall 11 of the box main body 10. The supporting portion 32 closes a side opposite to the insertion hole 31b of the tubular portion 31 and supports the relay 40 inserted inside the tubular portion 31 through the insertion hole 31b. As illustrated in FIG. 2, the supporting portion 32 is provided with a plurality of through holes 32a into which the respective terminals 42 of the relay 40 are passed. Each of the through holes 32a has the corresponding terminal 42 of the relay 40 passed thereinto when the relay 40 is mounted on the mounting unit 30.

A pair of openings 33 are formed on a corresponding pair of wall portions 31a of the tubular portion 31. In this case, the openings 33 are formed on respective wall portions 31a facing each other in the long side direction. The opening 33 is formed in the substantially center part of the wall portion 31a in the short side direction and in the insertion direction lower side of the wall portion 31a. The opening 33 penetrates the wall portion 31a in the facing direction (the long side direction) in which the openings 33 face each other. The opening 33 is rectangularly formed. A side 33a of the opening 33 is arranged parallel with the short side direction, and other sides 33b of the opening 33 are arranged parallel with the insertion direction.

A pair of arm portions 34 retains the relay 40. The arm portion 34 is formed in a strip shape and is provided to each opening 33. The arm portion 34 extends in a cantilever manner from an edge portion 33c of the opening 33 in the insertion hole 31b side to the supporting portion 32 side along the insertion direction. The arm portion 34 is formed such that, for example, an end 34a (a base end of the arm portion 34) of the arm portion 34 in the insertion direction upper side is continuous with the edge portion 33c of the opening 33 in the insertion hole 31b side. In other words, the arm portion 34 extends from the end 34a continuous with the edge portion 33c of the opening 33 in the insertion hole 31b side toward the supporting portion 32 side with another end 34b free and is arranged in a manner elastically deformable in the facing direction in which the openings 33 face each other. The arm portion 34 has a claw portion 34c locked to each of the pair of projecting portions 43 of the relay 40. The claw portion 34c is disposed on the other end 34b of the arm portion 34 and is formed in a manner projecting inward of the tubular portion 31 from the other end 34b. The claw portion 34c has an inclined surface 34d in the insertion direction upper side. The inclined surface 34d is a plane surface gradually inclined toward the front end of the claw portion 34c from the insertion direction upper side toward the insertion direction lower side. The arm portion 34 has the claw portion 34c locked to the projecting portion 43 of the relay 40, pushes the relay 40 inward of the tubular portion 31, and in this manner, retains the relay 40 inside the tubular portion 31.

The pair of first slits 35 allows each arm portion 34 to be elastically deformed. The first slits 35 are formed on respective sides of the arm portion 34 in an aligning direction that is a direction intersecting (preferably, perpendicularly intersecting) with the insertion direction, along the wall portion 31a having the opening 33 of the tubular portion 31. Each first slit 35 constitutes a part of the opening 33. More specifically, each first slit 35 penetrates the wall portion 31a in the facing direction. The first slit 35 extends, without getting out of the wall portion 31a, from the supporting portion 32 side toward the insertion hole 31b side along the insertion direction. In other words, the first slit 35 has a closed front end 35a in the insertion hole 31b side.

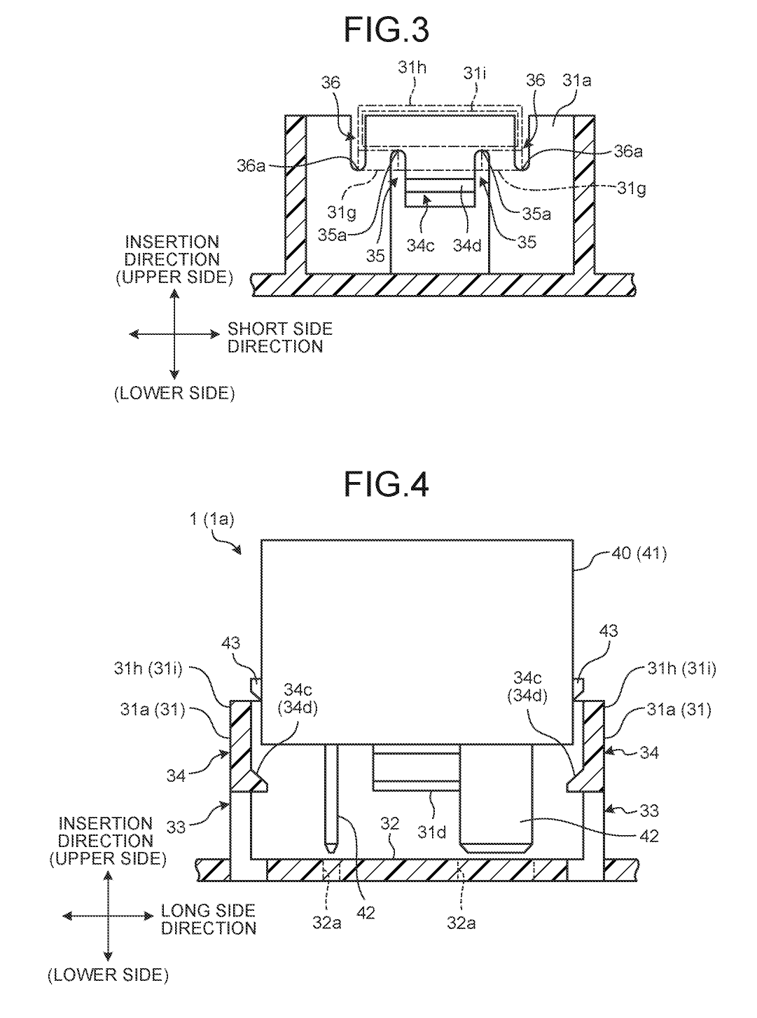

A pair of second slits 36 allows a part of the wall portion 31a to be elastically deformed. Each second slit 36 penetrates the wall portion 31a in the facing direction. The second slits 36 have the pair of first slits 35 interposed therebetween in the aligning direction, and each of the second slits 36 extends, without getting out of the wall portion 31a, from the insertion hole 31b toward the supporting portion 32 side along the insertion direction. In other words, the second slit 36 has a closed front end 36a in the supporting portion 32 side. As illustrated in FIG. 3, the second slits 36 overlap with the pair of first slits 35 in the aligning direction. More specifically, the second slit 36 has its front end 36a positioned close to the supporting portion 32 side compared to the front end 35a of the first slit 35. An overlapping wall portion 31g in which the second slit 36 and the first slit 35 overlap with each other in the aligning direction is formed in a pillar. The overlapping wall portion 31g supports an upper portion 31i of an inter-slit wall portion 31h formed between the pair of second slits 36 in a manner elastically deformable in the facing direction. When no external forces are applied, the overlapping wall portion 31g supports the upper portion 31i of the inter-slit wall portion 31h in parallel with the wall portion 31a continuous with the inter-slit wall portion 31h.

An exemplary function of the electric connection box 1 will now be described. As illustrated in FIG. 4, the electric connection box 1 has the relay 40 face the mounting unit 30 of the electric connection box 1 and has the relay 40 inserted into the tubular portion 31 of the mounting unit 30 from the terminal 42 side of the relay 40 from the insertion direction upper side toward the insertion direction lower side. In the electric connection box 1, the relay 40 in the tubular portion 31 is further guided to the center of the tubular portion 31 in the short side direction by the guiding members 31d.

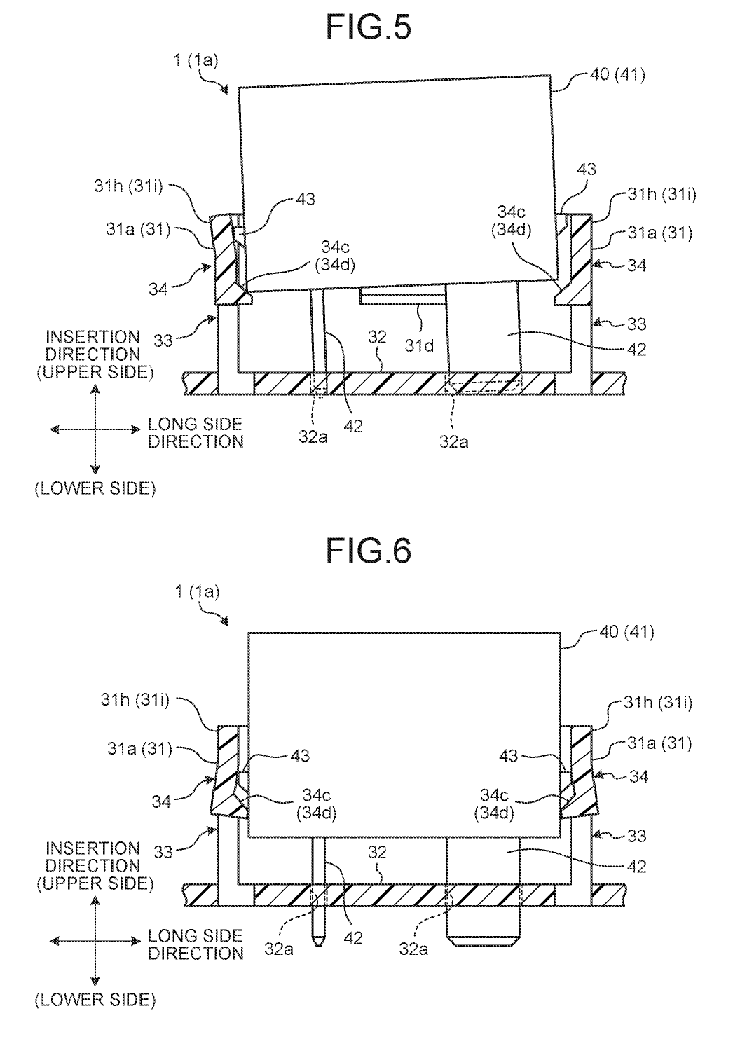

As illustrated in FIG. 5, when the electric connection box 1 has each terminal 42 of the relay 40 passed into the corresponding through hole 32a of the mounting unit 30 and accordingly has the main body 41 of the relay 40 inserted into the tubular portion 31 of the mounting unit 30, a pair of projecting portions 43 of the relay 40 may contact with the inner wall portions 31a of the tubular portion 31. In this case, in the electric connection box 1, the upper portion 31i of the inter-slit wall portion 31h contacting with each projecting portion 43 of the relay 40 is elastically deformed in the long side direction. More specifically, in the electric connection box 1, with the upper portion 31i of the inter-slit wall portion 31h supported by the overlapping wall portions 31g, the upper portion 31i of the inter-slit wall portion 31h is bent outward of the tubular portion 31 by being pushed outward of the tubular portion 31 by the projecting portion 43 of the relay 40. With this configuration, the electric connection box 1 can relieve the stress put on the wall portion 31a of the tubular portion 31 when the projecting portion 43 of the relay 40 contacts with the wall portion 31a of the tubular portion 31.

As illustrated in FIG. 6, in the electric connection box 1, when the main body 41 of the relay 40 contacts with the claw portions 34c of the pair of arm portions 34, the arm portions 34 each are elastically deformed. The claw portions 34c of the arm portions 34 are pushed outward of the tubular portion 31 by the main body 41 of the relay 40.

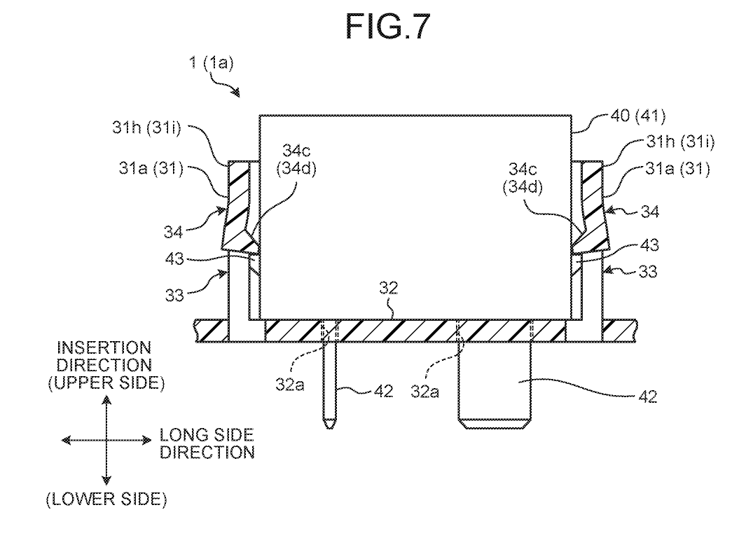

In the electric connection box 1, with the main body 41 of the relay 40 further pushed into the tubular portion 31, each claw portion 34c of the arm portion 34 climbs over the corresponding projecting portion 43 of the relay 40 and is locked to the projecting portion 43 of the relay 40 as illustrated in FIG. 7. With this process, the supporting portion 32 supports the bottom surface of the relay 40.

Consequently, in the electric connection box 1, the arm portions 34 retain the main body 41 of the relay 40 in the tubular portion 31 using the elastic restoring force of the arm portions 34. With the claw portions 34c of the arm portions 34 locked to the respective projecting portions 43 of the relay 40, the main body 41 of the relay 40 is fixed inside the tubular portion 31. In this manner, the electric connection box 1 has the relay 40 mounted on the mounting unit 30 of the box main body 10.

As described above, the electric connection box 1, the electronic component retaining structure la, and the wire harness 100 (which may be referred to as the electric connection box 1 and others) according to the embodiment include a pair of second slits 36 having a pair of first slits 35 interposed therebetween in the aligning direction, penetrating the wall portion 31a in the facing direction, extending from the insertion hole 31b toward the supporting portion 32 side along the insertion direction, having respective front ends 36a that are closed ends on the supporting portion 32 side, and overlapping with the first slits 35 in the aligning direction. With this configuration in the electric connection box 1 and others, a pair of overlapping wall portions 31g, on which the second slits 36 and the first slits 35 overlap with one another in the aligning direction, is formed in pillars. The electric connection box 1 and others are able to have the overlapping wall portions 31g support the upper portion 31i of the inter-slit wall portion 31h arranged between the second slits 36, in an elastically deformable manner. The electric connection box 1 and others are therefore able to have the upper portion 31i of the inter-slit wall portion 31h contacting with the projecting portion 43 of the relay 40 elastically deformed in the long side direction. In other words, in the electric connection box 1 and others, the upper portion 31i supported by the overlapping wall portions 31g of the inter-slit wall portion 31h is bent outward of the tubular portion 31 by being pushed outward of the tubular portion 31 by each projecting portion 43 of the relay 40. With this configuration, the electric connection box 1 and others can relieve the stress put on the wall portions 31a of the tubular portion 31 when the projecting portions 43 of the relay 40 contact with the wall portions 31a of the tubular portion 31. In this manner, the electric connection box 1 and others are able to properly mount the relay 40 on the tubular mounting unit 30. Moreover, the second slits 36 extend from the insertion hole 31b toward the supporting portion 32 side along the insertion direction without getting out of the wall portion 31a, which allows the electric connection box 1 and others to keep the rectangular box shape. The function of retaining the relay 40 is not therefore damaged.

In the electric connection box 1 and others, when the relay 40 contacts with the inter-slit wall portion 31h arranged between the second slits 36 in the process of the relay 40 being inserted through the insertion hole 31b, the tubular portion 31 has the inter-slit wall portion 31h elastically deformed. With this configuration, the electric connection box 1 and others can relieve the stress put on the inter-slit wall portions 31h of the tubular portion 31 when the projecting portions 43 of the relay 40 contact with the inter-slit wall portions 31h of the tubular portion 31.

Modification

A modification of the embodiment will now be described. The arm portion 34 and a pair of second slits 36 are provided on each of the pair of wall portions 31a facing each other in the long side direction; however, the embodiments are not limited to this configuration. The arm portion 34 and the second slits 36 are provided as appropriate in a manner corresponding to the position of the projecting portion 43 of the relay 40.

The electronic component retaining structure, the electric connection box, and the wire harness according to the embodiment include a pair of second slits having a pair of first slits interposed therebetween in an aligning direction, extending from an insertion hole toward a supporting portion side along an insertion direction, and overlapping with the pair of first slits in the aligning direction. In the electronic component retaining structure, the electric connection box, and the wire harness, when an electronic component contacts with an inter-slit wall portion arranged between the pair of second slits in the process of the electronic component being inserted through the insertion hole, the inter-slit wall portion is elastically deformed. This deformation can relieve the stress put on the inter-slit wall portion and exerts advantageous effects in properly mounting the electronic component on the mounting unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic component retaining structure comprising:
a tubular portion that is formed in a tubular shape and has an insertion hole to receive an electronic component inserted along an insertion direction;
a supporting portion that is provided on a side opposite to the insertion hole of the tubular portion and supports the electronic component;
a pair of arm portions that extends from respective edge portions of a pair of openings on the insertion hole side to the supporting portion side along the insertion direction in a cantilever manner and retains the electronic component, the openings being provided on respective wall portions facing each other of the tubular portion, facing each other, and penetrating the wall portions in a facing direction;
a pair of first slits that is provided on respective sides of the arm portions in an aligning direction that is a direction intersecting with the insertion direction, along the wall portions having the openings of the tubular portion, the first slits constituting parts of the respective openings, extending from the supporting portion side to the insertion hole side along the insertion direction, and having closed ends on the insertion hole side; and
a pair of second slits that is provided with the pair of first slits interposed therebetween in the aligning direction, the second slits penetrating the wall portions in the facing direction, extending from the insertion hole to the supporting portion side along the insertion direction, having closed ends on the supporting portion side, and overlapping with the pair of first slits in the aligning direction.

2. The electronic component retaining structure according to claim 1, wherein
when the electronic component contacts with an inter-slit wall portion arranged between the pair of second slits in a process of the electronic component being inserted through the insertion hole, the tubular portion has the inter-slit wall portion elastically deformed.

3. An electric connection box comprising:
an electronic component;
a tubular portion that is formed in a tubular shape and has an insertion hole to receive the electronic component inserted along an insertion direction;
a supporting portion that is provided on a side opposite to the insertion hole of the tubular portion and supports the electronic component;
a pair of arm portions that extends from respective edge portions of a pair of openings on the insertion hole side to the supporting portion side along the insertion direction in a cantilever manner and retains the electronic component, the openings being provided on respective wall portions facing each other of the tubular portion, facing each other, and penetrating the wall portions in a facing direction;
a pair of first slits that is provided on respective sides of the arm portions in an aligning direction that is a direction intersecting with the insertion direction, along the wall portions having the openings of the tubular portion, the first slits constituting parts of the respective openings, extending from the supporting portion side to the insertion hole side along the insertion direction, and having closed ends on the insertion hole side; and
a pair of second slits that is provided with the pair of first slits interposed therebetween in the aligning direction, the second slits penetrating the wall portions in the facing direction, extending from the insertion hole to the supporting portion side along the insertion direction, having closed ends on the supporting portion side, and overlapping with the pair of first slits in the aligning direction.

4. A wire harness comprising:
an electric connection box including:
an electronic component;
a tubular portion that is formed in a tubular shape and has an insertion hole to receive the electronic component inserted along an insertion direction;
a supporting portion that is provided on a side opposite to the insertion hole of the tubular portion and supports the electronic component;
a pair of arm portions that extends from respective edge portions of a pair of openings on the insertion hole side to the supporting portion side along the insertion direction in a cantilever manner and retains the electronic component, the openings being provided on respective wall portions facing each other of the tubular portion, facing each other, and penetrating the wall portions in a facing direction;
a pair of first slits that is provided on respective sides of the arm portions in an aligning direction that is a direction intersecting with the insertion direction, along the wall portions having the openings of the tubular portion, the first slits constituting parts of the respective openings, extending from the supporting portion side to the insertion hole side along the insertion direction, and having closed ends on the insertion hole side; and
a pair of second slits that is provided with the pair of first slits interposed therebetween in the aligning direction, the second slits penetrating the wall portions in the facing direction, extending from the insertion hole to the supporting portion side along the insertion direction, having closed ends on the supporting portion side, and overlapping with the pair of first slits in the aligning direction; and
an electric wire that is electrically connected with the electronic component.
